(19) United States
(12) Patent Application Publication
(10) Pub. No.: US 2013/0127704 A1
(43) Pub. Date: May 23, 2013

(54) SPATIAL TOUCH APPARATUS USING SINGLE INFRARED CAMERA

(71) Applicants: Kwang Mo JUNG, Yongin-si (KR); Sung Hee HONG, Seoul (KR); Byoung Ha PARK, Seoul (KR); Young Choong PARK, Seoul (KR); Kwang Soon CHOI, Goyang-si (KR); Yang Keun AHN, Seoul (KR)

(72) Inventors: Kwang Mo JUNG, Yongin-si (KR); Sung Hee HONG, Seoul (KR); Byoung Ha PARK, Seoul (KR); Young Choong PARK, Seoul (KR); Kwang Soon CHOI, Goyang-si (KR); Yang Keun AHN, Seoul (KR)

(73) Assignee: KOREA ELECTRONICS TECHNOLOGY INSTITUTE, Seongnam-si (KR)

(21) Appl. No.: 13/527,256

(22) Filed: Jun. 19, 2012

(30) Foreign Application Priority Data
Nov. 18, 2011 (KR) 10-2011-0120670

(51) Int. Cl. G09G 5/00; H04N 5/33

(52) U.S. Cl. 345/156

(57) ABSTRACT

The present disclosure relates to a spatial touch apparatus using a single infrared camera. More particularly, it relates to a spatial touch apparatus to implement a virtual touch screen in a free space by using an infrared light emitting diode (LED) array and a single infrared camera and to calculate X-axis and Z-axis coordinates of the infrared screen touched by a user indication object. Therefore, the present invention will provide tangible and interactive user interfaces to users and can implement more various user interfaces (UI) than a conventional 2D touch apparatus.

### BACKGROUND OF THE INVENTION

1. Field of the invention

The present invention relates to a spatial touch apparatus using a single infrared camera, and more particularly to a spatial touch apparatus which includes an infrared Light Emitting Diode (LED) array and a single infrared camera, so as to implement a virtual touch screen in a free space.

2. Description of the Prior Art

Recently, wide use has been made of a touch screen, which can directly receive input from a user on a screen thereof in such a manner that, when the user's finger or an object touches a character displayed on a screen or a particular location thereon without using a keyboard, the touched location can first be detected and then particular processing can be performed by stored software.

The touch screen can previously display character information or picture information, so that the user can easily understand a function to be selected by the user. Therefore, the touch screens have been applied to and have been variously utilized for devices for guiding, terminals for vending machines at various stores, devices for ordinary business purposes, etc. in places such as subway stations, department stores, banks, etc.

FIG. 1 is a perspective view showing a conventional spatial touch apparatus using multiple infrared cameras.

As shown in FIG. 1, the conventional three-dimensional (3D) spatial touch apparatus using multiple infrared cameras is equipped with infrared cameras at left and right sides of an infrared screen, and recognizes input from a user indication object by a method for cross-sensing the input from the user indication object through the two cameras.

Accordingly, the conventional 3D spatial touch apparatus using multiple infrared cameras requires a high cost in order to install two cameras, and has a configuration for correctly sensing a user indication object only when the number of user indication objects is one. Therefore, it has a disadvantage in that an error occurs when one camera senses two user indication objects.

Further, there is a problem in that an angle and a position between the two cameras need to be precisely adjusted. In addition, due to sensing of only a part where the angle of view of one camera overlaps that of the other camera, a disadvantage occurs in that a sensing region is narrow.

### SUMMARY OF THE INVENTION

Therefore, the present invention has been made to solve the above-mentioned problems occurring in the prior art, and an object of the present invention is to provide a spatial touch apparatus using a single infrared camera, which can recognize a position (X-axis and Z-axis coordinates) touched by a user, in a free space away from a display device, and can process an instruction from the user based on the recognized touched position.

In order to accomplish the above-mentioned object, there is provided a spatial touch apparatus using a single infrared camera. The spatial touch apparatus using a single infrared camera includes: an infrared light emitting diode (LED) array for generating an infrared screen in a space by emitting infrared rays; a single infrared camera mounted above or below a center part of the infrared LED array such that a lens thereof faces the infrared screen; and a spatial touch recognition module for calculating X-axis and Z-axis coordinates of the infrared screen touched by a user indication object, by using an image captured by the infrared camera.

Also, the spatial touch apparatus further includes: a pulse generator for periodically generating a pulse signal; and an LED driver for supplying direct current (DC) power to the infrared LED array when the pulse signal is input from the pulse generator, and interrupting supply of the DC power to the infrared LED array when the pulse signal is not input from the pulse generator.

Also, the infrared camera captures an image when the pulse signal is input from the pulse generator.

Further, the spatial touch recognition module includes: a difference image acquirer for acquiring a difference image by performing a subtraction operation of subtracting a pixel value of a previously-stored background image from a pixel value of the image captured by the infrared camera; a binarizer for acquiring a binary image by performing a thresholding operation on the difference image acquired by the difference image acquirer; a smoother for eliminating a noise from the binary image by smoothing the binary image binarized by the binarizer; a labeler for labeling the binary image, from which the noise has been eliminated by the smoother; and a coordinate calculator for detecting a blob having a size equal to or larger than a predetermined size among blobs labeled by the labeler, and calculating center coordinates of the blob having the size equal to or larger than the predetermined size.

### BRIEF DESCRIPTION OF THE DRAWINGS

The above and other objects, features and advantages of the present invention will be more apparent from the following detailed description taken in conjunction with the accompanying drawings, in which:

FIG. 1 is a perspective view showing a conventional spatial touch apparatus using multiple infrared cameras;

FIG. 2 is a perspective view showing a spatial touch apparatus using a single infrared camera, according to an exemplary embodiment of the present invention;

FIG. 3 is a block diagram showing an internal configuration of a spatial touch apparatus using a single infrared camera, according to an exemplary embodiment of the present invention;

FIGS. 4A and 4B are views showing the principle of recognizing a spatial touch in a spatial touch apparatus using a single infrared camera, according to an exemplary embodiment of the present invention;

FIG. 5 is a block diagram showing an internal configuration of a spatial touch recognition module according to an exemplary embodiment of the present invention; and

FIG. 6 is a flowchart showing a method for recognizing a spatial touch by a spatial touch apparatus using a single infrared camera, according to an exemplary embodiment of the present invention.

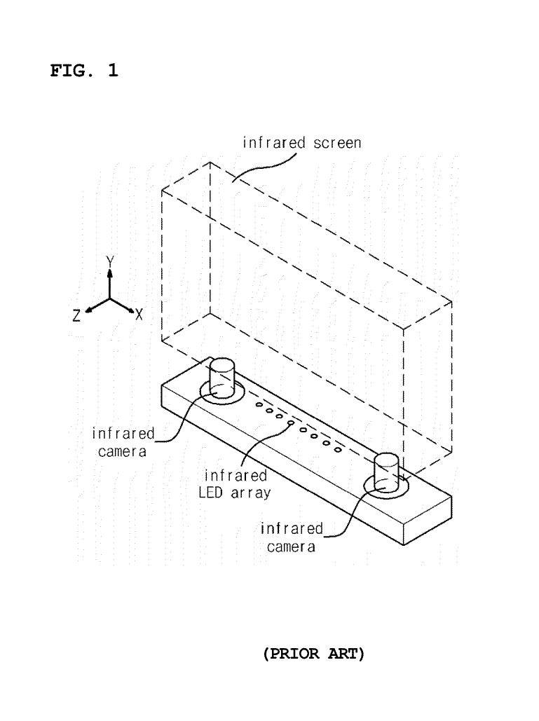

### DETAILED DESCRIPTION OF THE PREFERRED EMBODIMENTS

Hereinafter, in order to describe the invention in detail so that the invention may be easily practiced by a person having an ordinary knowledge in the technical field, to which the present invention pertains, exemplary embodiments of the present invention will be described in detail with reference to the accompanying drawings.

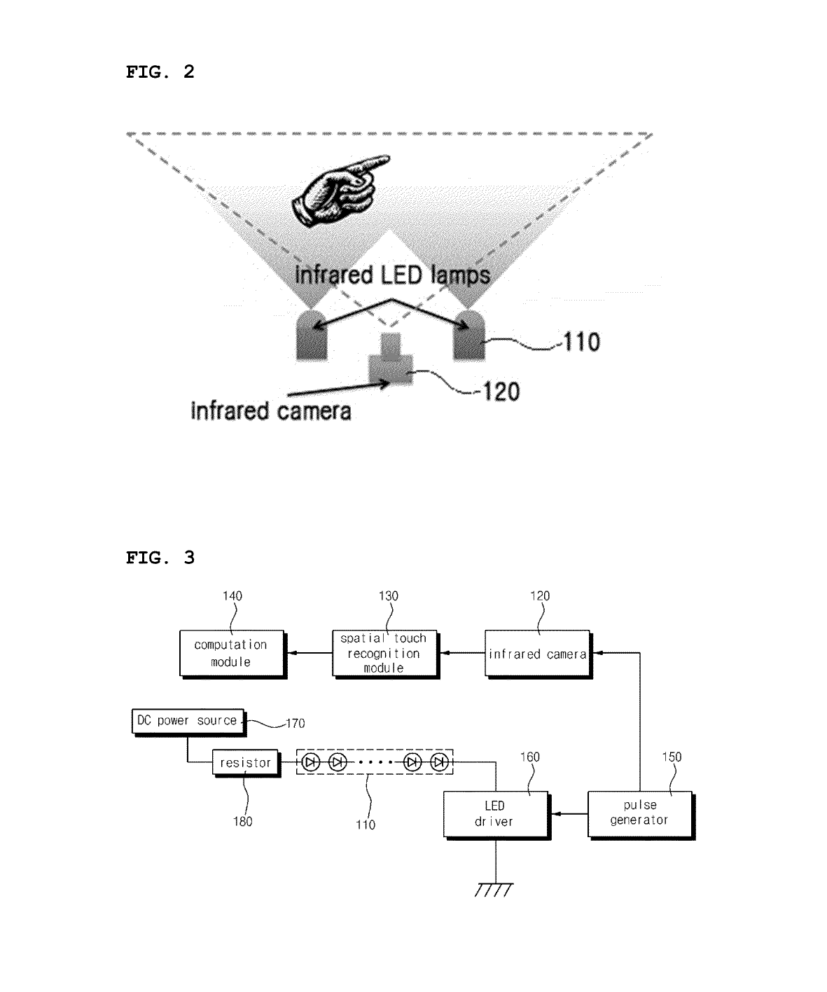

FIG. 2 is a perspective view showing a spatial touch apparatus using a single infrared camera according to an exemplary embodiment of the present invention.

As shown in FIG. 2, the spatial touch apparatus using a single infrared camera according to an exemplary embodiment of the present invention includes an infrared LED array 110 which generates an infrared screen in a space by emitting infrared rays, an infrared camera 120 which is mounted above or below a center part of the infrared LED array 110 and captures the infrared screen, and a spatial touch recognition module 130 which recognizes a position where a user indication object (e.g. a fingertip or a stylus pen) touches the infrared screen in a gray scale image captured by the infrared camera 120.

Hereinafter, the configuration of the present invention will be described in detail. First, the infrared screen is a virtual touch screen in a space, which is generated by the infrared LED array 110.

The transverse length of the infrared screen is determined by the number of infrared LEDs arranged in a line.

It is preferable that the infrared LED array 110 includes narrow-angle infrared LEDs. In other words, it is preferable that the infrared beam angle of the infrared LED array 110 has a value within 10 degrees. Herein, because the infrared LEDs are semiconductor devices widely used in the technical field to which the present invention pertains, a detailed description thereof will be omitted.

As is well known to those skilled in the art, the infrared camera 120, which has a built-in filter for cutting off a visible light region and passing only an infrared region, first blocks visible light generated by indoor fluorescent lamps and the like, and then captures only infrared rays in the form of a gray-scale image.

Further, the infrared camera 120 is mounted such that a lens thereof faces the infrared screen.

FIG. 3 is a block diagram showing an internal configuration of a spatial touch apparatus using a single infrared camera, according to an exemplary embodiment of the present invention.

Referring to FIG. 3, the spatial touch apparatus using a single infrared camera according to an exemplary embodiment of the present invention may further include a pulse generator 150 for periodically generating a pulse signal, an LED driver 160 for driving the infrared LED array 110 in response to a pulse signal periodically received as input from the pulse generator 150, and a resistor 180 disposed between a DC (Direct Current) power source 170 and the infrared LED array 110.

In the above-described configuration, the pulse generator 150 generates pulse signals having, for example, a width of 100 μs and a period of 10 ms.

The LED driver 160, specifically, supplies DC power to the infrared LED array 110 when it receives as input a pulse signal from the pulse generator 150. In contrast, when the LED driver 160 does not receive as input the pulse signal from the pulse generator 150, it interrupts the supply of the DC power to the infrared LED array 110.

Namely, the LED driver 160 does not keep the infrared LED array 110 turned on, but drives the infrared LED array 110 in response to a pulse signal. A reason for requiring pulse driving instead of constant current driving as described above is as follows.

An LED is typically operated in a constant current driving scheme or a pulse driving scheme, and is brighter when being operated in the pulse driving scheme than when being operated in the constant current driving scheme. Namely, the pulse driving scheme allows a higher current to flow through the LED than does the constant current driving scheme, and thus can produce brighter light. However, because the LED may be damaged by the pulse driving scheme, it is required to control time, that is, a pulse width.

For example, when an LED is driven by a pulse, a current of 1 A can flow through the LED. In contrast, when the LED is driven by a constant current, a current of 100 mA can flow through the LED. When the LED is operated in the pulse driving scheme instead of the constant current driving scheme as described above, it is possible to obtain a brightness ten times greater than that obtained by the constant current driving scheme. Accordingly, it is possible to reduce an error in recognizing a touch, which may be caused by external light (for example, sunlight, the light of a fluorescent lamp, and the light of an incandescent lamp).

Meanwhile, just as a camera takes a photograph when a flash thereof goes off, the infrared camera 120 captures an image when it receives as input a pulse signal from the pulse generator 150.

The spatial touch recognition module 130 extracts positional coordinates of a position where the user indication object enters, from an image captured by the infrared camera.

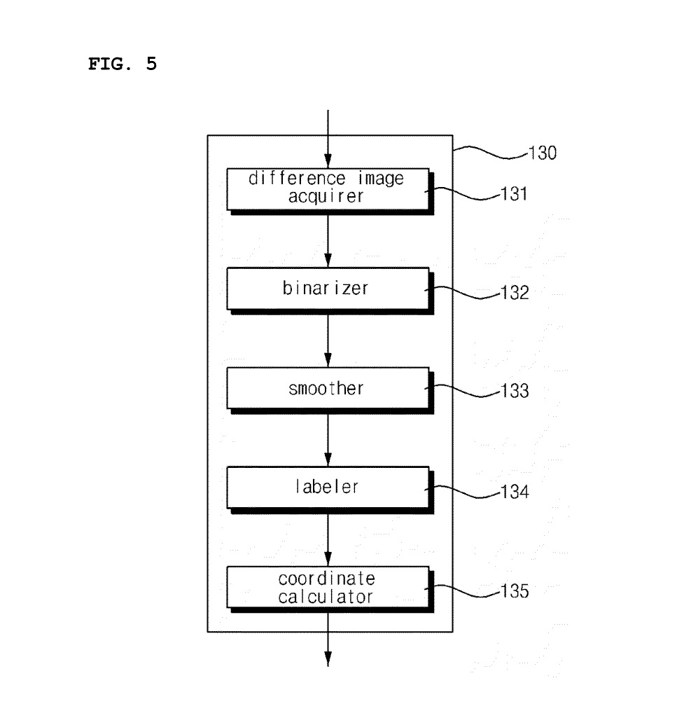

Detailed components of the spatial touch recognition module 130 will be described below with reference to FIG. 5.

When a computation module 140 receives the positional coordinates of the user indication object from the spatial touch recognition module 130, it recognizes the positional coordinates as the selection of a particular function displayed at a position on the screen, which is matched with the positional coordinates, and performs the relevant function. For example, when a user first puts a finger deep into a fore part of the infrared screen and then moves it leftward, the computation module 140 recognizes the motion as a drag motion, and performs the relevant function.

Also, when the computation module 140 receives multiple positional coordinates from the spatial touch recognition module 130, it performs a particular relevant function according to a change in the distance between the multiple positional coordinates.

Further, the computation module 140 is connected to an external device through a wired or a wireless network. If so, the external device may be controlled by using the positional coordinates recognized by the spatial touch recognition module 130. In other words, when the positional coordinates correspond to a control instruction for controlling the external device, the external device is caused to perform a relevant function. Herein, the external devices may include a home network household electrical appliance and a server, which are connected through a network.

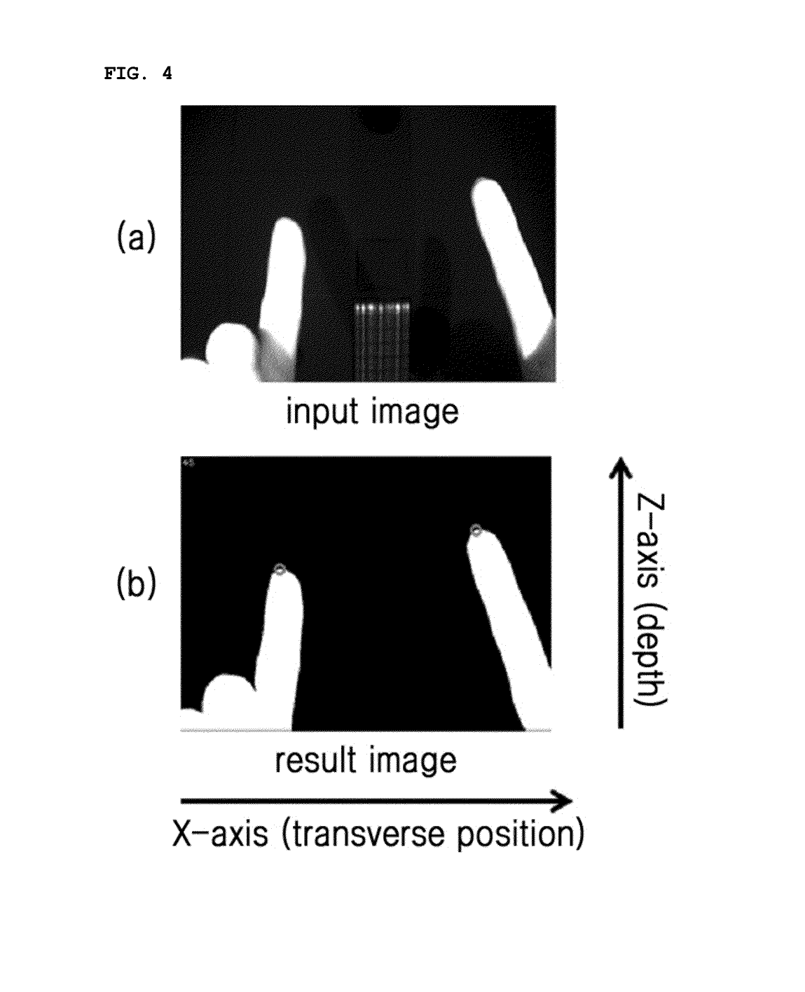

FIGS. 4A and 4B are views showing the principle of recognizing a spatial touch in a spatial touch apparatus using a single infrared camera, according to an exemplary embodiment of the present invention. FIG. 5 is a block diagram showing an internal configuration of a spatial touch recognition module according to an exemplary embodiment of the present invention.

An image captured by the infrared camera 120 is black in color, due to infrared rays emitted by the infrared LED array 110 before the user indication object (the user's finger) enters the infrared screen.

However, when the user indication object, that is, the user's fingertip enters the infrared screen, infrared rays are scattered or diffused at a part of the infrared screen that the user's fingertip enters, so that the part where the user indication object is located looks bright, as shown in FIGS. 4A and 4B. As a result, when the user's fingertip is found by performing image processing on this part which looks bright, it is possible to find the X-axis and Z-axis coordinates of the infrared screen touched by the user indication object (the user's fingertip).

The spatial touch recognition module 130 includes a difference image acquirer 131, a binarizer 132, a smoother 133, a labeler 134, and a coordinate calculator 135.

When the difference image acquirer 131 receives as input a camera image (i.e. input image) from the infrared camera 120, it acquires a difference image (i.e. source image) by performing a subtraction operation of subtracting a pixel value of a previously-stored background image from a pixel value of the input image.

When the binarizer 132 receives as input the difference image corresponding to the gray-scale image as shown in FIG. 4A from the difference image acquirer 131, it binarizes the received difference image. Specifically, the binarizer 132 binarizes the difference image in such a manner that it adjusts the value of a pixel, which is not larger than a predetermined threshold, to “0” (black), for each pixel and changes the value of a pixel, which is not smaller than the predetermined threshold, to “255” (white) for each pixel.

The smoother 133 eliminates noise from the binary image by smoothing the binary image binarized by the binarizer 132.

The labeler 134 labels the binary image smoothed by the smoother 133. Specifically, the labeler 134 labels the pixels, the values of which have all been adjusted to 255. For example, the labeler 134 reconstructs the binary image by assigning different numbers to white regions (blobs) by using an 8-neighboring pixel labeling technique. As described above, the labeling operation is a technique widely used in the field of image processing, and thus a detailed description thereof will be omitted.

The coordinate calculator 135 calculates the center coordinates of a blob having a size equal to or larger than a predetermined threshold among the blobs labeled by the labeler 134. Specifically, the coordinate calculator 135 first regards the blob, the size of which is equal to or larger than the predetermined threshold, as a finger or an object that touches the infrared screen, and then calculates the center coordinates of the relevant blob. In this case, the center coordinates may be detected by using various detection methods. For example, the coordinate calculator 135 takes intermediate values of the X-axis and Z-axis minimum values and the X-axis and Z-axis maximum values of the relevant blob, as the center of gravity, and determines the intermediate values as the relevant coordinates of the touch.

Also, when there are multiple blobs each having a size equal to or larger than the predetermined threshold, the coordinate calculator 135 may calculate multiple center coordinates.

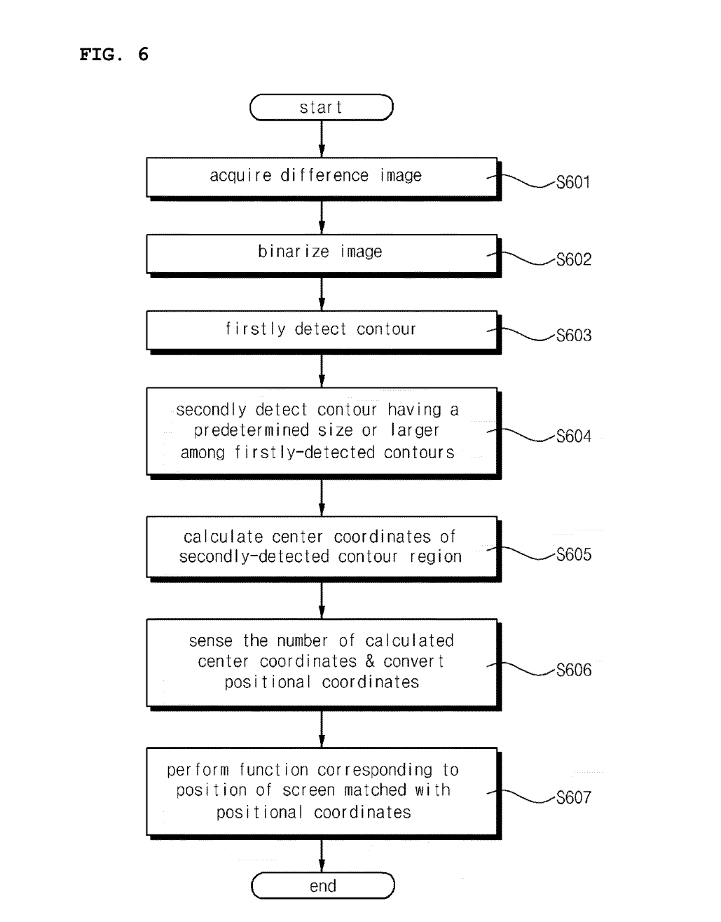

FIG. 6 is a flowchart showing a method for recognizing a spatial touch by a spatial touch apparatus using a single infrared camera, according to an exemplary embodiment of the present invention.

First, in step S601, when the spatial touch recognition module 130 receives as input a gray-scale image from the infrared camera 120, it acquires a difference image through a subtraction operation of subtracting a pixel value of a previously-stored background image from a pixel value of the input image.

Then, in step S602, the spatial touch recognition module 130 binarizes and smoothes the acquired difference image.

Next, in step S603, the spatial touch recognition module 130 labels the binarized and smoothed image, and detects a contour corresponding to the user indication object (finger) among the labeled blobs.

In step S604, the spatial touch recognition module 130 secondly detects a contour having a predetermined size or larger among the firstly-detected contours. In step S605, the spatial touch recognition module 130 calculates the center coordinates of the secondly detected contour region. In this case, the number of secondly detected contour regions may be plural.

In step S606, the spatial touch recognition module 130 converts the calculated center coordinates into the center coordinates of the infrared screen. In step S608, the spatial touch recognition module 130 delivers the converted center coordinates to the computation module 140.

Then, in step S607, the computation module 140 performs a function corresponding to position information recognized by the spatial touch recognition module 130.

The spatial touch apparatus using a single infrared camera according to the present invention is not limited to the embodiments as described above, and can be variously modified and implemented without departing from the scope and spirit of the invention.

The present invention relates to a spatial touch apparatus using a single infrared camera, and has an effect in which it can provide users with a more realistic and interactive User Interface (UI) and can provide them with pleasure and convenience. Therefore, kiosks to which the present invention is applied will provide such tangible user interfaces in the near future.

Particularly, by utilizing the Z-axial coordinate of the infrared screen as depth information and the like, the spatial touch apparatus as described above can implement more various user interfaces than can an apparatus for touching a projection of a 2D image of the related art.

Although the preferred embodiments of the present invention have been described for illustrative purposes, those skilled in the art will appreciate that various modifications, additions and substitutions are possible, without departing from the scope and spirit of the invention as disclosed in the accompanying claims.

What is claimed is:

1. A spatial touch apparatus using a single infrared camera, the spatial touch apparatus comprising:
an infrared light emitting diode (LED) array for generating an infrared screen in a space by emitting infrared rays;
a single infrared camera mounted above or below a center part of the infrared LED array such that a lens thereof faces the infrared screen; and
a spatial touch recognition module for calculating X-axis and Z-axis coordinates of the infrared screen touched by a user indication object, by using an image captured by the infrared camera.

2. The spatial touch apparatus as claimed in claim 1, further comprising:
a pulse generator for periodically generating a pulse signal; and
an LED driver for supplying direct current (DC) power to the infrared LED array when the pulse signal is input from the pulse generator, and interrupting supply of the DC power to the infrared LED array when the pulse signal is not input from the pulse generator.

3. The spatial touch apparatus as claimed in claim 2, wherein the infrared camera captures an image when the pulse signal is input from the pulse generator.

4. The spatial touch apparatus as claimed in claim 1, wherein the spatial touch recognition module comprises:
a difference image acquirer for acquiring a difference image by subtracting a pixel value of a previously-stored background image from a pixel value of the image captured by the infrared camera;
a binarizer for acquiring a binary image by performing a thresholding operation on the difference image acquired by the difference image acquirer;
a smoother for eliminating a noise from the binary image by smoothing the binary image binarized by the binarizer;
a labeler for labeling the binary image, from which the noise has been eliminated by the smoother; and
a coordinate calculator for detecting a blob having a size equal to or larger than a predetermined size among blobs labeled by the labeler, and calculating center coordinates of the blob having the size equal to or larger than the predetermined size.
